(19) United States
(12) Patent Application Publication
(10) Pub. No.: US 2014/0183874 A1
(43) Pub. Date: Jul. 3, 2014

(54) Pumped Swing Based Spinning System

(71) Applicants: PEDRO ENRIQUE VALDERRAMA, LOS TEQUES (VE); CARLOS EDUARDO VIERA, MIAMI, FL (US)

(72) Inventors: PEDRO ENRIQUE VALDERRAMA, LOS TEQUES (VE); CARLOS EDUARDO VIERA, MIAMI, FL (US)

(21) Appl. No.: 14/033,386

(22) Filed: Sep. 20, 2013

Related U.S. Application Data
(60) Provisional application No. 61/704,554, filed on Sep. 23, 2012.

(51) Int. Cl. H02K 7/18

(52) U.S. Cl. CPC H02K 7/1853
USPC 290/1 E

(57) ABSTRACT

Our invention is a Pumped Swing Based Spinning System, where we managed to find a combination of viscous fluid and metal spheres within a hollow structure that swings back and forth driven by gravitational acceleration, and springs at the end of every swing to pump the pendulum and drive an energy gain that is higher than the expected energy loss from friction and resistance from the power generator rotor. It is simple, self-dependent, efficient and scalable. We believe it can be applied to generate electricity in a continuous and very efficient way.

### CROSS-REFERENCE TO RELATED APPLICATIONS

This application claims the benefit of U.S. Provisional Application No. 61/704,554 filed on Sep. 23, 2012.

### STATEMENT REGARDING FEDERALLY SPONSORED RESEARCH OR DEVELOPMENT

Not Applicable

### REFERENCE TO SEQUENCE LISTINGS, A TABLE, OR A COMPUTER PROGRAM LISTING COMPACT DISC APPENDIX

Not Applicable

### BACKGROUND OF THE INVENTION

Our invention falls under the Class 185 of the U.S. patent classification definition. Basically this is the class of spring, weight, and animal powered motors, and it is specific to motors of these types and to plural arrangements of such motors.

Our invention is a spinning system powered by springs, weight and gravity. It does not require any winding means. It is simple, self-dependent, efficient and scalable. We believe it can be applied to generate electricity in a continuous and very efficient way.

In our research we found that traditional forms of energy are expensive, non-renewable fossil fuels dependent, not environment friendly and complex to distribute when it comes to electricity. On the other hand different forms of alternative renewable energies that derive their power from the different forces on the planet are victims of sudden increase or decrease in the intensity of these forces.

Our invention or system is a compelling alternative that addresses these issues to offer a very simple and clean form of energy generation.

### BRIEF SUMMARY OF THE INVENTION

As we described before our invention is a spinning system powered by weight, springs and gravity. It is simple, self-dependent, efficient and scalable. We believe it can be applied to generate electricity in a continuous and very efficient way.

This approach to generate electricity takes advantage of forces we find in our planet. The System makes these forces harmonize together to obtain the ultimate consolidated spinning movement. It does not require any rather expensive fossil fuel.

This System is driven by gravitational acceleration which is constant, therefore it offers many advantages, when compared with the different forms of renewable alternative energies that derive their power from the different forces on the planet but they are victims of sudden increase or decrease in the intensity of these forces; or suffer from the intermittency of these forces.

This System also can be used to generate energy on site, in other words if we apply it to generate electrical power, this one can be generated right where it is needed, saving significant electricity distribution costs.

One of the most interesting features of this System is its scalability. This System is based on a model that is adaptable or scalable to the required demand. It scales-up to compete with a fuel or thermonuclear power plant.

Needless to say, this System is clean, reduces tons of CO2 that are deposited into the atmosphere. One of the materials required for their manufacture is a recyclable material and highly polluting of the environment that will help lower the cost of production and makes this System environment friendly.

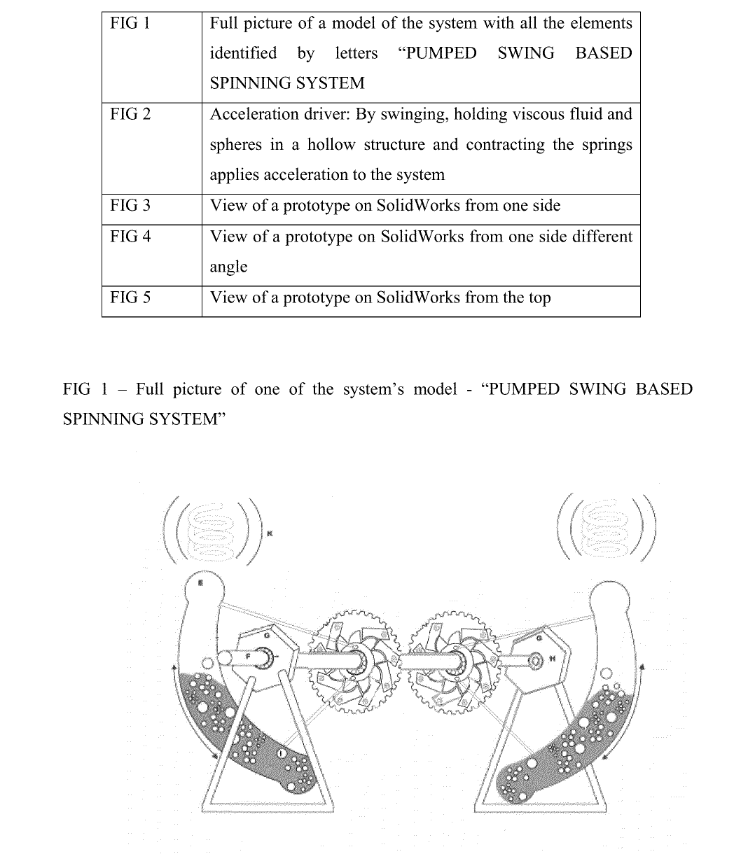

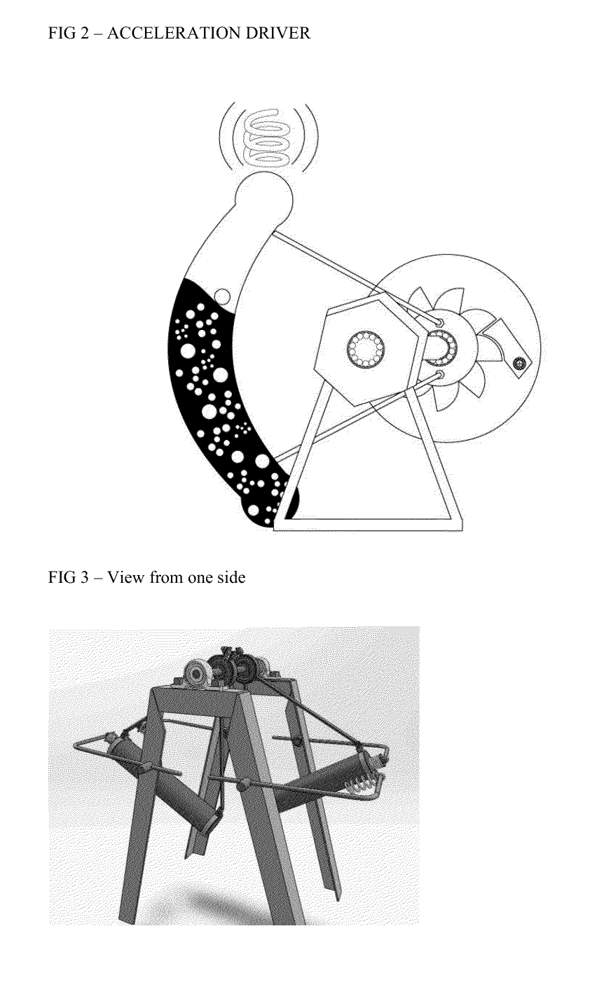

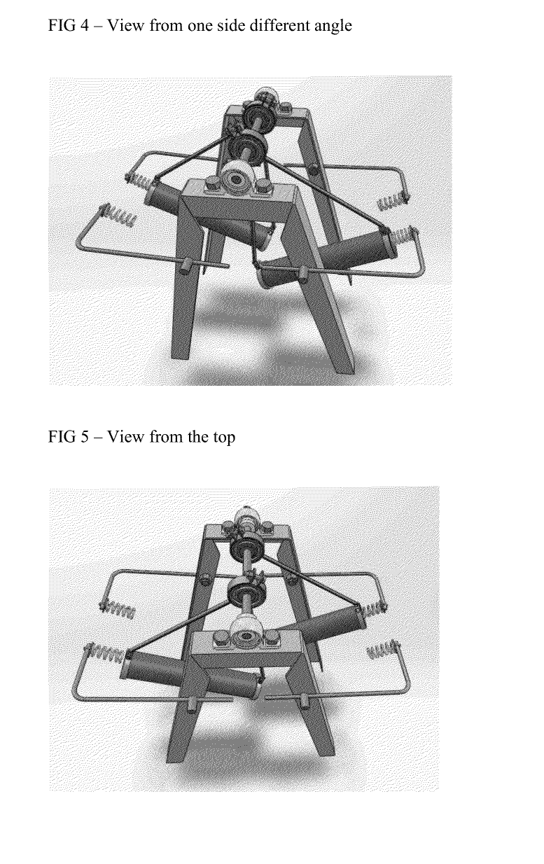

### BRIEF DESCRIPTION OF THE SEVERAL VIEWS OF THE DRAWING

| | |
|---|---|
| FIG. 1 | Full picture of a model of the system with all the elements |
| | identified by letters “PUMPED SWING BASED |
| | SPINNING SYSTEM |
| FIG. 2 | Acceleration driver: By swinging, holding viscous fluid and |
| | spheres in a hollow structure and contracting the springs |
| | applies acceleration to the system |
| FIG. 3 | View of a prototype on SolidWorks from one side |
| FIG. 4 | View of a prototype on SolidWorks from one side different |
| | angle |
| FIG. 5 | View of a prototype on SolidWorks from the top |

### DETAILED DESCRIPTION OF THE INVENTION

We decided to include a full picture of a model that shows what this system consists of in terms of motion, components and forces in this Detailed Description.

This system is driven by 2 ACCELERATION DRIVERS, identified by the letter E on FIG. 1 and also showed on FIG. 2. The ACCELERATION DRIVER is based on a hollow structure filled with metal spheres together with a viscous liquid identified by letter I on FIG. 1. This viscous liquid can be burned oil from any motor. This makes the invention environment friendly. It uses the mass and gravity of the spheres and the viscous liquid and the springs at every end of the swing to pump the pendulum swing, drive acceleration to the system and create additional energy to offset the energy loss from friction and the power generator resistance.

The ACCELERATION DRIVER is subject to a crankshaft identified by letter F on FIG. 1, with a system that will allow ratchet half twist in one direction. In this way when we include 2 ACCELERATION DRIVERS we can tune the system to guarantee a continuous minimum spinning force throughout a complete turn or cycle. We can use a ratchet as we show on FIGS. 1 and 2, or we can use one way spinning ball bearings.

The ACCELERATION DRIVER, gets its acceleration from the pumping onto the swing generated by the spheres and the viscous liquid within the hollow structure and the springs, as we show on FIG. 2. By tuning up all the system's variables we can guarantee the additional energy coming from the swing pumping will be more than the energy loss from the friction and the power generator resistance.

This system is able to consolidate the energy generated by the ACCELERATION DRIVERS on the spinning movement. Therefore by integrating some couplers to this system, it will be able to apply this force to one or even multiple power generator rotor.

The crankshaft features thickness and rigidity capable of withstanding the weight and movement of the ACCELERATION DRIVERS. It is on this crankshaft where the ball bearings are placed (letter H on FIG. 1), most recommended ceramic ball bearings because of the low maintenance over the years.

The Bases are identified by letter G on FIG. 1. This base must have lateral wings where the springs will be set to drive additional acceleration to ACCELERATION DRIVER and hence to the system. On FIGS. 3, 4 and 5 we show views of a prototype that includes the wings with the springs.

The additional energy driven by the swing pumping generated by the springs together with the viscous fluid and the spheres located in the hollow structure part of the ACCELERATION DRIVER, must be higher than the energy loss from the friction and the power generator rotor's resistance in order for this system to work. Our objective for the next step is to work on a thorough analysis and tune up all the variables to make sure the energy loss is always below the energy gain.

Having a spinning motion system that is driven by mass and gravity we can size it to generate enough energy to drive any size power generator rotor(s) by adding couplers and/or gearing boxes to the model and ultimately generate electricity.

Our initial project once we get the patent approval is to work on tuning all the variables to obtain the optimum system based on this idea and have it deployed in a real electrical power generation facility to test it as what we suggest it.

1. We claim as our invention the combination of viscous fluid with metal spheres inside the hollow structure that swings back and forth as a pendulum does driven by gravity, with springs at the end of every swing to stop and bounce back the hollow structure, as mechanism to pump the pendulum swing and drive additional energy to the system that overcomes the expected energy loss from friction and any additional resistance coming from any rotor this system will be applying the energy.
